(19) United States
(12) Patent Application Publication
(10) Pub. No.: US 2025/0049068 A1
(43) Pub. Date: Feb. 13, 2025

(54) METHOD OF PRODUCING GELATINE USING CUTTING DEVICE

(71) Applicant: Tessenderlo Group NV, Brussels (BE)

(72) Inventors: Douglas Rodrigues FRANCISQUINI, Pontypridd (GB); Giles A, Verheecke, Davenport, IA (US)

(21) Appl. No.: 18/718,450

(22) PCT Filed: Dec. 22, 2022
(86) PCT No.: PCT/EP2022/087563

§ 371 Date: Jun. 11, 2024

(30) Foreign Application Priority Data
Dec. 23, 2021 (EP) 21217348.8

(51) Int. Cl. A23J 1/10; A23J 3/06; A23J 3/34; B24C 1/04

(52) U.S. Cl. CPC A23J 1/10; A23J 3/06; A23J 3/342; B24C 1/045

(57) ABSTRACT

The present invention relates to a method of producing gelatine, the method comprising the steps of: providing animal material containing collagen; cutting the animal material with at least one fluid cutting jet to form animal material sections; hydrolysing the collagen in the animal material sections to form gelatine; and isolating the gelatine. The invention also relates to a fluid jet cutting device and to the use of a fluid jet cutting device in the production of gelatine. The invention is particularly useful in the production of gelatine from pig skin and/or cow hides and/or fish skin.

### TECHNICAL FIELD

The present invention relates to a method of producing gelatine using a cutting device and to the use of a cutting device in the production of gelatine. The invention is particularly useful in the production of gelatine from pig skin and/or cow hides and/or fish skin.

### BACKGROUND

Gelatine is a translucent, colourless, flavourless food ingredient, commonly derived from collagen taken from animal body parts. It is brittle when dry and gummy when moist. It may also be referred to as hydrolysed collagen, collagen hydrolysate, gelatine hydrolysate, hydrolysed gelatine, and collagen peptides after it has undergone hydrolysis. It is commonly used as a gelling agent in food, beverages, medications, drug and vitamin capsules, photographic films and papers, and cosmetics.

Gelatine is generally derived from animal material such as pork skins, cattle hides, or fish skin. The raw materials can be prepared by different curing, acid, and alkali processes that are employed to extract the collagen. These processes may take several weeks, and differences in such processes have effects on the production speed and quality of the final gelatine products. Gelatine generally is prepared by extraction from pre-treated raw materials resulting in gelatine being dissolved into the water. Depending on the gelatine concentration, the resulting stock, when cooled, will form a jelly or gel naturally.

While many processes exist whereby collagen may be converted to gelatine, they all have several factors in common. The intermolecular and intramolecular bonds that stabilize insoluble collagen must be broken, and the hydrogen bonds that stabilize the collagen helix must be broken. The manufacturing processes of gelatine usually starts with a pre-treatment stage. Here, the raw materials are prepared for the main extraction step and impurities are removed that may have negative effects on physicochemical properties of the final gelatine product. This step involves cutting the animal material into smaller sections to improve uniformity of the processing, in particular in order to allow a more uniform enzymatic and chemical treatment. Cutting is conventionally done with knives or blades, in particular when the raw material is animal skins or hides. Having smaller sections of animal material increases the control on the later processing steps.

In following steps, the collagen in the raw material is hydrolysed to form gelatine. Next, the gelatine is extracted from the hydrolysis mixture, which usually is done with hot water or dilute acid solutions as a multistage process. Finally, a selection of refining and recovery treatments are performed, such as filtration, clarification, evaporation, sterilization, drying, grinding, and sifting to remove the water from the gelatine solution, to blend the extracted gelatine, and to obtain dried, blended, ground final product. Additional steps may be added to the above process, or certain processing steps may be omitted, depending on the requirements of the final product.

Examples of such conventional cutting methods are described in document CN203683562U, which relates to a skin segmentation machine having a segmented conveyor and a plurality of disk cutters. As the skin is advanced over the conveyor, it is cut by the disk cutters into strips. Another example is disclosed in CN104231943A, which relates to a method of manufacturing gelatine, wherein hide is cut into small pieces using either a circular knife or a horizontal knife combined with a cutting machine.

The inventor realised that these cutting methods result in relatively high yield losses with high wastewater treatment cost as consequence. In particular, the use of existing cutting methods appeared to result in a substantial amount of fine tissue particles, which could be overtreated in the subsequent processing steps. On average, known cutting methods appear to generate about 5%-10% of small particles, which are lost in the gelatine production. The high variability of raw material sizes affects the treatment, because a strong treatment will dissolve the small pieces and a softer treatment will not treat the big ones. Also, great part of small particles will pass through the washer's screens, which will end up in the wastewater treatment plant, increasing the costs substantially.

There is thus a need for an improved method of cutting animal material for the production of gelatine. The present invention provides for such a solution.

### SUMMARY OF THE INVENTION

The present invention relates in a first aspect to a method of producing gelatine comprising the steps of: providing animal material containing collagen; cutting the animal material with at least one fluid cutting jet to form animal material sections; hydrolysing the collagen in the animal material sections to form gelatine; and isolating the gelatine.

In an embodiment of the first aspect, the cutting step may include a stabilizing step, preferably a compressing step, which allows for keeping the animal material in place while cutting. This stabilizing step prevents unnecessary movements of the animal material caused by fluid cutting jet and ensures the animal material sections are cut as desired. Preferably, the animal material is placed on a rigid material for cutting such as metal, metal alloy, stainless steel. More preferably, the animal material is placed on a stainless-steel belt conveyor.

The present invention relates in a further aspect to a fluid jet cutting device for cutting animal material for the production of gelatine, said fluid jet cutting device comprising: a first belt conveyor defining a feed direction; at least one fixed fluid jet cutting head, preferably at least three fluid jet cutting heads, arranged to provide a fixed fluid cutting jet; at least one moving fluid jet cutting head, arranged to provide a moving fluid cutting jet, the moving fluid cutting jet being arranged to achieve a first velocity component on the first belt conveyor, said first velocity component being perpendicular to the feed direction.

In an embodiment of the further aspect, the fluid jet cutting device is further provided with at least one stabilizing assembly configured to hold or fix the animal material located under a fluid jet cutting head. The fluid jet cutting head may be the at least one fixed fluid jet cutting head and/or the at least one moving fluid jet cutting head. The stabilizing assembly may be connected to the fluid jet cutting head. Preferably, the stabilizing assembly is a compressing assembly, and more preferably it is a compressing roller assembly. The compressing roller assembly includes at least one compressing roller having a rolling direction that is in line with a desired cutting direction. Since the direction of the fluid jet is normally in the direction of gravity, the strength of the compression is determined by the total weight applied on the animal material. The stabilizing assembly, preferably compressing roller assembly, may include a weight holder. The weight holder allows for varying the total weight of the stabilizing assembly and adjusting for conditions of animal materials. For example, a thicker load of animal material might require stronger compressing force to keep the material in place. However, if the compressing force is too strong, the force may create undesired small fractions of animal material which can lower the yield.

In a preferred embodiment, the stabilizing assembly is a compressing roller assembly containing two compressing rollers installed on each side of a fluid jet nozzle of the fluid jet cutting head. This two-rollers configuration allows for a more stable fixation of the animal material around the fluid jet cutting head.

In still a further aspect, the present invention relates to the use of a fluid jet cutting device for cutting animal material for the production of gelatine. In an embodiment, the animal material is placed on a rigid material for cutting such as metal, metal alloy, stainless steel. More preferably, the animal material is placed on a stainless-steel belt conveyor. The stainless-steel belt conveyor may be in form of wire mesh, perforated belt, or any other shape which can form a rigid surface with a tension. The stainless-steel belt conveyor may include a set of cogwheels mechanically connected to a belt to ensure a rigid and/or tense surface is formed where the animal material is placed on.

With the invention, material loss is reduced, better yield will be obtained and lower solids and COD (chemical oxygen demand) will be delivered to the wastewater treatment plant. Furthermore, whereas conventional blades will dull over time, causing more friction and thus an increase in temperature, the use of a fluid cutting jet to cut the animal material maintains more constant process parameters.

### DETAILED DESCRIPTION

The drawings illustrate the design and utility of embodiments, in which similar elements are referred to by common numerals. These drawings are not necessarily drawn to scale. These drawings depict only exemplary embodiments and are not therefore to be considered limiting in the scope of the claims.

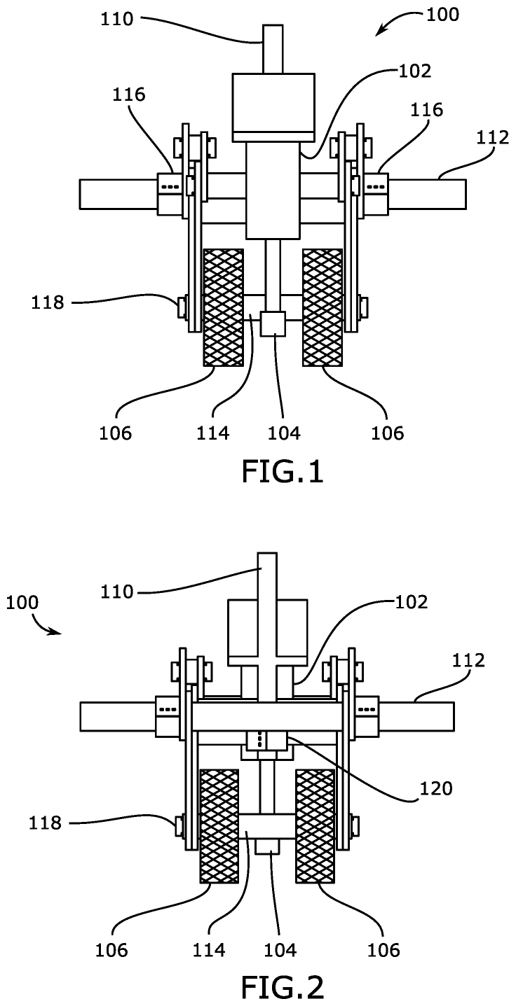

FIG. 1 illustrates a front view of a fluid jet cutting device having a compressing roller assembly.

FIG. 2 illustrates a rear view of the fluid jet cutting device of FIG. 1.

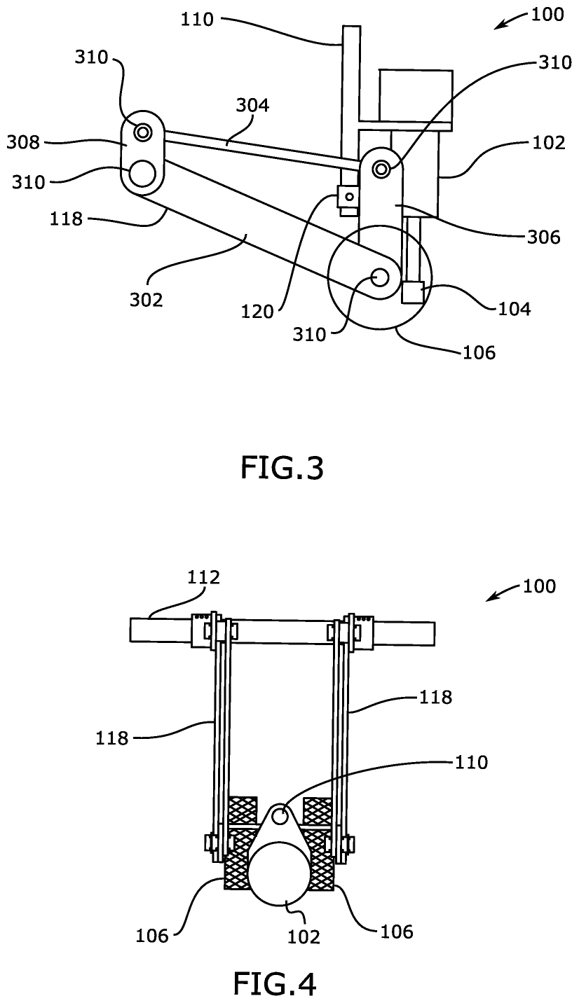

FIG. 3 illustrates a side view of the fluid jet cutting device of FIG. 1.

FIG. 4 illustrates a top view of the fluid jet cutting device of FIG. 1.

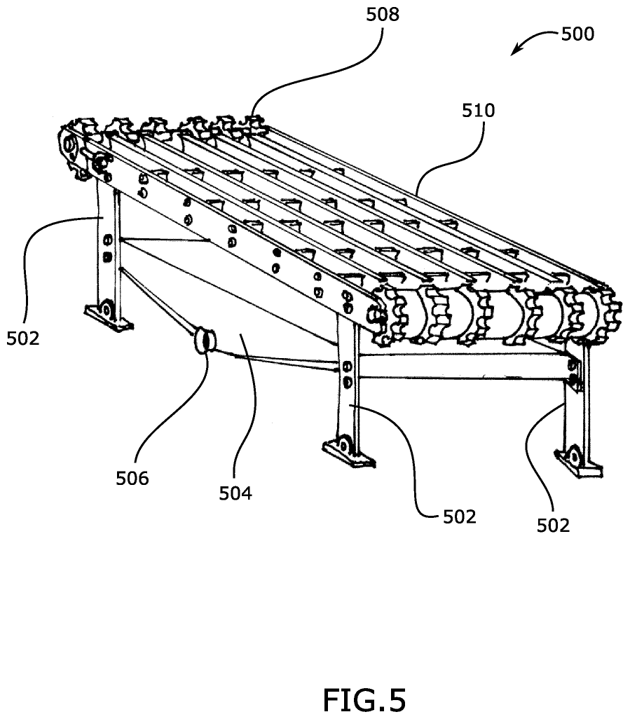

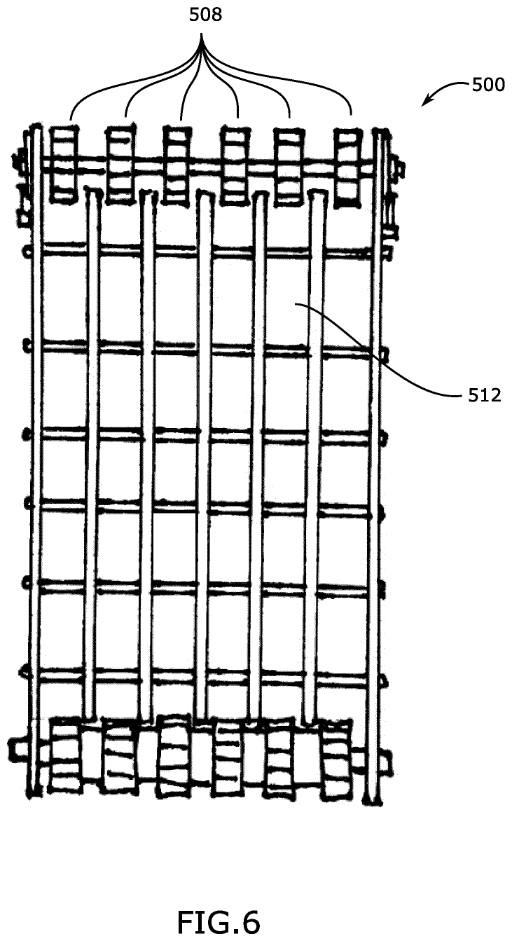

FIG. 5 illustrates a belt conveyor having a set of cogwheels, a base with openings, and a waste container. For clear illustration of the set of cogwheels, the belt is omitted.

FIG. 6 illustrates a top view of the belt conveyor of FIG. 5.

### DETAILED DESCRIPTION

The present invention relates in a first aspect to a method of producing gelatine comprising the steps of: providing animal material containing collagen; cutting the animal material with at least one fluid cutting jet to form animal material sections; hydrolysing the collagen in the animal material sections to form gelatine; and isolating the gelatine.

In an embodiment of the first aspect, the cutting step b. may further comprise stabilizing the animal material with stabilizing means, preferably by compressing the animal material with at least one compressing roller, which allows for keeping the animal material in place while cutting. This stabilizing step prevents unnecessary movements of the animal material caused by fluid cutting jet and ensures the animal material sections are cut as desired. Preferably, the animal material is placed on a rigid material for cutting such as metal, metal alloy, stainless steel. More preferably, the animal material is placed on a stainless-steel belt conveyor.

The stabilizing step is preferred as animal skin is gummy and elastic, which makes it difficult to keep it in one place under strong external force such as a fluid jet. A stabilizing means can ensure the animal material is stably kept in one location on a surface such as a conveyor belt.

Various stabilizing methods may be used to stabilize the animal material. For example, a compressing roller assembly may be connected to a fluid jet cutting head and configured to physically press a part of the animal material that is located adjacent to the fluid jet cutting head. The roller configuration allows for maintaining the compressing force while the animal material is moving, such as moving along a conveyor belt. Another advantage of compressing roller assembly is that it can stably compress an animal material that has a varying height along a cutting line. More preferably, the animal material is compressed using two compressing rollers arranged to have at least one fluid cutting jet in between. This allows the material on each side of the at least one fluid cutting jet to be stabilized while cutting. Another stabilizing method uses two types of belts, a conveyor belt and a stabilizing belt. When an animal material is placed on a conveyor belt and moving along a feed direction, one or more stabilizing belt can be placed on partially top of the animal material near the edges of the conveyor belt. The stabilizing belt is configured to hold the animal material in place either by its weight or by a connection mean that mechanically connects the stabilizing belt to the conveyor belt and compressing the animal material in between.

It is noted that any other stabilizing method which can prevent unnecessary movement of the animal material can be used.

Gelatine may refer to hydrolysed collagen, collagen hydrolysate, gelatine hydrolysate, hydrolysed gelatine, and collagen peptides after it has undergone hydrolysis. Animal material may comprise skins such as pig skin, cow hides, fish skins, or the like and may comprise soft collagen containing materials, such as cartilage.

A fluid cutting jet is understood to encompass the fluid cutting stream from a pressurized jet cutter. The fluid may comprise water but may also comprise oils, oil-water emulsions, pastes, gels, aerosols and air or other gases. The fluid may further comprise abrasives, such as fine solid materials. In a preferred embodiment, the fluid is a liquid, preferably water, in such case typically the fluid cutting jet is known as a water cutting jet or water jet cutting or water jet cutter.

The use of a fluid cutting jet to cut the animal material greatly lowers the raw material losses and improves the pre-treatment of the animal material. This increases the yield, production rates, and reduces the environmental impact. Specifically, the use of a fluid cutting jet reduces the production of small particles, leading to a higher material yield and lowered environmental impact due to the introduction of small particles or higher COD to the wastewater treatment. Further, the precision of the cuts is increased, thus limiting the overtreatment of small particles, while the temperature of the animal material is not greatly altered by the fluid cutting jet. The fluid cutting jet ensures a smooth cut on the animal material, resulting in a higher homogeneity of animal material treatment and thus a higher yield in the gelatine production process.

The fluid cutting jet may utilize any fluid appropriate for cutting the animal material. The fluid cutting jet is not limited to the use of water. The animal material may be frozen, defrosted, dried or semi-dried prior to cutting.

Collagen is the main component of connective tissues in animals and humans. Collagen consists of chains of amino acids wound together to form triple-helices which in turn form elongated fibrils. It is mostly found in fibrous tissues such as tendons, ligaments and skin. It is also found in bones, teeth, corneas, cartilage, intervertebral discs and blood vessels. Collagen for industrial processing is mostly derived from animal skin and/or bones. Collagen may be processed to produce gelatine, which is obtained by irreversible, partial hydrolysis of collagen. According to the Food Chemical Codex, gelatine is defined as the product obtained from the acid, alkaline, or enzymatic hydrolysis of collagen, the main protein component of the skin, bones, and connective tissue of animals, including fish and poultry. Gelatine is typically characterized by a gel strength (gelatine has the ability to form gels of various strengths, depending on the gelatine properties) and in warm solution by a certain viscosity. This gelatine can be further hydrolysed to shorter protein chains to produce collagen hydrolysate, losing its ability to form a gel and becoming even soluble in water at ambient temperatures. Hydrolysis can be done by an enzymatic treatment for example.

In a preferred embodiment, the animal material is animal skin such as for example pig skin, beef hide, sheep skin, fish skin.

The animal material sections may have any appropriate shape such as, but not limited to, rectangular, square, trapezoid, rhomboid, parallelogram, polygonal, triangular, ovoid, or spheroid. These shapes may define a major distance, corresponding to the longest side of the shape, or alternatively to the diameter or width of the shape. In an embodiment, the animal material sections have a major distance of between 1 cm and 50 cm, preferably of between 3 cm and 40 cm, still more preferably of between 5 cm and 20 cm.

In an embodiment, the animal material sections have a rectangular, square, trapezoid, or rhomboid shape, defining a first side length of between 1 cm and 50 cm, preferably of between 3 cm and 40 cm, still more preferably of between 5 cm and 20 cm and a second side length of between 1 cm and 50 cm, preferably of between 3 cm and 40 cm, still more preferably of between 5 cm and 20 cm.

In an embodiment, the animal material is cut with a fluid jet cutting device comprising a first belt conveyor defining a feed direction, wherein the first belt conveyor transports the animal material with a feed velocity in the feed direction; at least one fixed fluid jet cutting head; and at least one moving fluid jet cutting head, arranged to provide a moving fluid cutting jet, the moving fluid cutting jet being arranged to achieve a first velocity component on the first belt conveyor, said first velocity component being perpendicular to the feed direction.

In a preferred embodiment, the at least one moving fluid jet cutting head is arranged to move diagonally over the first belt conveyor. In an embodiment, the at least one moving fluid jet cutting head is arranged to provide a moving fluid cutting jet having a second velocity component on the first belt conveyor along the feed direction, said second velocity component being substantially equal to the feed velocity.

In an embodiment, the animal material is cut with a fluid jet cutting device comprising a first belt conveyor defining a feed direction, at least one fixed fluid jet cutting head being arranged to provide a fixed fluid cutting jet to the first belt conveyor, a second belt conveyor defining a second feed direction, and at least one fixed fluid jet cutting head being arranged to provide a fixed fluid cutting jet to the second belt conveyor, wherein said feed direction and said second feed direction are non-parallel. Preferably, the feed direction and the second feed direction are substantially orthogonal. In an embodiment, the animal material may be oriented such that the second feed direction is non-parallel with respect to a direction of the cuts provided by the at least one fixed fluid jet cutting head being arranged to provide a fluid cutting jet to the first belt conveyor. It shall be appreciated that the first and second conveyors are provided such that they allow for two sets of non-parallel cuts in the animal material. In an embodiment, the fluid jet cutting device comprises at least two fixed fluid jet cutting heads, preferably at least three fixed fluid jet cutting heads. Such an arrangement is particularly advantageous for smaller animal material sections which are easier to transfer from the first belt conveyor to the second belt conveyor.

In an embodiment the fluid cutting jet is provided at a pressure of at least 3000 bar, preferably at least 5000 bar, more preferably at least 5400 bar, still more preferably at least 6000 bar. The pressure of the fluid cutting jet refers to the pressure of the water in the fluid jet cutting head.

In an embodiment, the at least one fluid jet cutting head comprises a cutting head orifice of between 0.01 mm and 1 mm, preferably of between 0.05 mm and 0.5 mm, more preferably of between 0.1 mm and 0.3 mm, still more preferably of between 0.15 mm and 0.2 mm.

In an embodiment, the animal material comprises animal skins wherein the skins are stacked prior to cutting the animal skins with the fluid cutting jet, the stack having a thickness of between about 0.1 cm and 40 cm, preferably of between about 0.5 cm and 30 cm, more preferably of between about 1 cm and 20 cm, still more preferably of between about 2 cm and 15 cm.

In an embodiment, the fluid cutting jet comprises an abrasive material, wherein preferably the abrasive material comprises a solid food-grade material. In an embodiment, the abrasive material is a product that is used during gelatine processing and/or a by-product of gelatine processing. In an embodiment, the abrasive material may comprise animal material. In an embodiment, the abrasive material comprises one or more of bone dust, sodium bicarbonate, dicalcium phosphate, lime, solid acid, such as for example citric acid.

The present invention relates in a further aspect to a fluid jet cutting device for cutting animal material for the production of gelatine, said fluid jet cutting device comprising: a first belt conveyor defining a feed direction; at least one fixed fluid jet cutting head, preferably at least three fixed fluid jet cutting heads, arranged to provide a fixed fluid cutting jet; and at least one moving fluid jet cutting head, arranged to provide a moving fluid cutting jet, the moving fluid cutting jet being arranged to achieve a first velocity component on the first belt conveyor, said first velocity component being perpendicular to the feed direction.

In an embodiment, the first belt conveyor is arranged to achieve a feed velocity in the feed direction and the at least one moving fluid jet cutting head is arranged to move diagonally over the first belt conveyor, the moving fluid cutting jet having a second velocity component on the first belt conveyor, along the feed direction being equal to the feed velocity.

FIG. 1 illustrates an embodiment of the first aspect of the present invention wherein the fluid jet cutting device 100 is provided with a stabilizing assembly 118. In this non-limiting illustrated embodiment, the stabilizing assembly is at least one compressing roller assembly 118 configured to compress the animal material located under a fluid jet cutting head 102. The fluid jet cutting device 100 comprising the compressing roller assembly 118 and the fluid jet cutting head 102 is connected to a support element 112 via connecting elements 116. The support element 112 may be linear or non-linear. The connecting elements 116 may be permanently fixed to the support element 112 or movably connected to the support element 112 in a manner that the fluid jet cutting device 100 can move along an axial direction of the support element 112.

The fluid jet cutting head 102 is provided with a fluid jet nozzle 104 where a pressurized fluid jet is released.

The compressing roller assembly 118 includes at least one compressing roller 106 having a rolling direction that is in line with a desired cutting direction. Since the direction of the fluid jet is normally in the direction of the gravity, the strength of the compression is determined by the total weight of the fluid jet cutting device. The fluid jet cutting device may include a weight holder 110. The weight holder 110 may be connected to the fluid jet cutting head 102. The weight holder 110 allows for varying the total weight of the fluid jet cutting device 100 and for adjusting according to particular conditions of animal materials. For example, a thicker load of animal material might require stronger compressing force to keep the material in place. However, if the compressing force is too strong, the force may create undesired small fractions of animal material which can lower the yield.

The compressing roller assembly 118 may contain one or more compressing rollers 106. As shown in FIG. 1, if two compressing rollers 106 are installed on each side of a fluid jet nozzle of the fluid jet cutting head, it allows for a more stable fixation of the animal material around the fluid jet cutting head 102 than having only one compressing roller 106. The two compressing rollers 106 may be connected via an axial support where the compressing rollers 106 are installed while allowing rotational movements. As mentioned, the compressing force/power can be adjusted by varying the weight load on the weight holder 110.

FIG. 2 illustrates a rear view of the fluid jet cutting device 100 shown in FIG. 1. The fluid jet cutting head 102 is connected to a weight holder which is further connected to the compressing roller assembly 118 via a connecting member 120.

FIG. 3 illustrates a side view of the fluid jet cutting device 100 shown in FIG. 1. The compressing roller assembly 118 comprises at least one compressing roller 106 which can compress an animal material under the fluid jet nozzle 104 of the fluid jet cutting head 102. The components shown in FIG. 3 may also provide on the opposite side.

The compressing roller assembly 118 may further comprise first and second connecting arms 302, 304, first and second vertical connecting members 306, 308 configured to maintain the vertical position of the fluid jet cutting head 102.

In FIG. 3, it is shown that the compressing roller assembly 118 is connected to the fluid jet cutting head via a weight holder 110 by using a connecting member 120 of the first vertical connecting member 306. However, it is noted that the connection may be performed directly between the compressing roller assembly 118 and the fluid jet cutting head 102.

The first and second vertical connecting members 306, 308 are connected via the first and second connecting arms 302, 304 by using joints 310 and configured to keep the fluid jet cutting head 102 in a vertical position while allowing a movement along a vertical direction. The joints 310 may have a mechanical spring element having a compressive strength. The compressive strength of the mechanical spring element may determine the resistance of the fluid jet cutting device 100 to the vertical movements. For example, when the compressing roller is rolling on a surface that is elevating, pushing the fluid jet cutting device upward, a mechanical spring with a large compressive strength will resist the upward movement with increasing compressing force given by the mechanical spring. Therefore, the compressive strength of the mechanical spring can be chosen according to different conditions of the animal material, i.e., thickness of the animal material.

FIG. 4 illustrates a top view of the fluid jet cutting device 100 of FIG. 1.

A conveyor is understood to comprise any device that allows for the movement of a product or a material. The moving fluid jet cutting head 102 may comprise a system for moving the fluid jet cutting head 102 in a plane substantially parallel to the conveyor. Alternatively or additionally, the fluid jet cutting head 102 may be provided on a rotational actuation device, which may tilt the fluid jet cutting head 102 in a desirable direction. For example, the moving fluid jet cutting head may be linearly actuated in a direction substantially orthogonal to the feed direction, so that it moves laterally over the width of the conveyor. To compensate for the movement of the animal material over the conveyor, e.g. to produce squares rather than rhomboids or trapezoids, the fluid jet cutting head may be rotationally tilted during the lateral movement over the conveyor so that the fluid cutting jet is deviated in the feed direction. The moving fluid jet cutting head 102 may utilize any appropriate combination of rotational and/or linear movement to attain an appropriate shape of the animal material sections.

FIG. 5 illustrates an embodiment of a belt conveyor 500. The belt conveyor 500 comprises a base 510 with a plurality of openings 512, a belt with a plurality of openings (not illustrated), a set of cogwheels 508, support frames 502. Preferably, the belt conveyor 500 further comprises a waste container 504 which may store wastes produced during cutting and the wastes are releasable via a drain 506.

The belt is formed by a rigid material with a plurality of openings. The material can be any suitable material such as metal, metal alloy, stainless steel, suitable polymer composite and the like. The belt may be in form of a wire mesh, perforated belt, or any other shape which can form a rigid surface with a tension and allow the wastes to flow down to the base 510. Preferably the belt is stably configured such that it forms a rigid surface that can withstand external forces such as a fluid jet, ensuring that the belt is not moving up and down or in any direction other than a feed direction of the belt. More preferably the belt is in a tensed condition to form a rigid surface which ensures the belt is not moving up and down or in any direction other than a feed direction of the belt. Such configuration of the belt ensures unnecessary movement of the animal material and thus more efficient cutting.

The base 510 may comprise a plurality of openings 512 which allow the waste produced during cutting procedure to be collected in a waste container 504. The base 510 may further comprise a set of cogwheels 508 which can be mechanical connected to the belt via the plurality of openings of the belt. The mechanical connection allows for stably maintaining the tension of the surface of the belt. The tension of the belt surface allows stable cutting of the animal materials avoiding unnecessary movements of the animal materials.

In an embodiment, the fluid jet cutting device comprises 2-10 fixed cutting heads, said fixed cutting heads preferably being provided at a predetermined distance to each other in a direction orthogonal to the feed direction.

In an embodiment, the fluid jet cutting heads are provided at an adjustable height above the first belt conveyor of between 1 cm and 50 cm, preferably of between 5 cm and 30 cm, more preferably of between 10 cm and 20 cm.

In a preferred embodiment, the fluid jet cutting heads are provided at a height above the animal material of between 1 mm and 100 mm, preferably of between 3 mm and 30 mm, more preferably of between 4 mm and 15 mm.

In an embodiment, the fluid jet cutting heads are arranged to introduce an abrasive material in the fluid cutting jets, wherein preferably the abrasive material comprises a solid food-grade material. In an embodiment, the abrasive material is a product that is used during gelatine processing and/or a by-product of gelatine processing. In an embodiment, the abrasive material may comprise animal material. In an embodiment, the abrasive material comprises one or more of bone dust, sodium bicarbonate, dicalcium phosphate, lime, solid acid, such as for example citric acid.

In still a further aspect, the present invention relates to the use of a fluid jet cutting device for cutting animal material for the production of gelatine.

### EXAMPLES

### Example 1: Skin Cutting with Five Beef Hide Trimming

A fluid jet cutting device is provided, having a first belt conveyor defining a feed direction; four fluid jet cutting heads, arranged to provide four fixed fluid cutting jets; and one moving fluid jet cutting head, arranged to provide one moving fluid cutting jet, wherein the first belt conveyor is arranged to achieve a feed velocity in the feed direction, and wherein the at least one moving fluid jet cutting head is arranged to move diagonally over the first belt conveyor, the moving fluid cutting jet having a second velocity component on the first belt conveyor along the feed direction, being substantially equal to the feed velocity.

Five pig skins are provided to the first belt conveyor of the cutting device, the five pig skins being stacked on top of each other. The pig skins being transported by the first belt conveyor through the fixed fluid cutting jets, which cut the pig skins in five strips (per skin). After having sliced the pig skins using the fixed fluid cutting jets, the moving fluid cutting jet cuts the strips into squares by moving across the first belt conveyor. To compensate for the speed of the skins on the first conveyor, the moving fluid cutting jet has a second velocity component on the first belt conveyor along the feed direction, which is substantially equal to the feed velocity, i.e. the speed of the pig skins. As a result, the moving fluid cutting jet only has a lateral component with respect to the pig skins. As a result, the cuts of the fixed fluid cutting jets and the moving fluid cutting jets will be substantially orthogonal.

As a result, the great precision of the cut avoids the formation of small pieces of beef hides which normally happens in the standard cutting devices. The generation of fine material is normally from 5 to 10% and could reach up to 20% depending on how the quality of the cutter blades and design of the equipment. Considering a production line of 5k tonnes per year and a reduction of 80% of the small pieces of skin, the results will be around the figures below:

TABLE 1
estimation of 10% of losses
ESTIMATION LOSSES - 10% Fines

| | | |
|---|---|---|
| Example of annual production | 5000 | tonnes |
| Yield | 15% | |
| Raw material consumption | 33,333 | tonnes |
| % fines | 10% | |
| Losses over fines | 80% | |
| Raw material lost | 2,667 | tonnes |
| Potential yield increase | 1.3% | |

The improvement on yield will also bring an important reduction in the solids disposal in the waste water treatment plant (wwtp). The current reference shows around 1.5-2.0% of fibers are removed in the wwtp per total amount of beef hides chopped. For a plant producing 5,000 tonnes of gelatin per year, with an yield around 15%, this value represents between 500 to 667 tonnes of fibers disposed. It is estimated that the waterjet technology could help to reduce this fibers generation by 30-50%.

The lower generation of fibers during the raw material cutting process will reduce the soluble COD inlet the wastewater treatment plant. This will reflect in a lower energy needed in the aeration ponds, due to less blowers will be used to keep the oxygen levels. Some plant trials, taken samples before and after the acidulation of beef hides, showed an average reduction of 77% on soluble COD. For limed treated beef hides, there will be another reduction during the alkaline treatment. The total reduction will depend on the initial COD load inlet the process, which varies from beef hides, pig and fish skins.

The following clauses detail a number of aspects and/or features of the present invention.
Clause 1. A method for producing gelatine, the method comprising the steps of:
   a. providing animal material containing collagen;
   b. cutting the animal material with at least one fluid cutting jet to form animal material sections;
   c. hydrolysing the collagen in the animal material sections to form gelatine; and
   d. isolating the gelatine.
Clause 2. The method of clause 1, wherein the animal material sections have a rectangular, square, trapezoid, or rhomboid shape, defining a first side length of between 1 cm and 50 cm, preferably of between 3 cm and 40 cm, still more preferably of between 5 cm and 20 cm and a second side length of between 1 cm and 50 cm, preferably of between 3 cm and 40 cm, still more preferably of between 5 cm and 20 cm.
Clause 3. The method of any of the preceding clauses, wherein the animal material is cut with a fluid jet cutting device comprising: a first belt conveyor defining a feed direction, wherein the first belt conveyor transports the animal material with a feed velocity in the feed direction; at least one fixed fluid jet cutting head; and at least one moving fluid jet cutting head, arranged to provide a moving fluid cutting jet, the moving fluid cutting jet being arranged to achieve a first velocity component on the first belt conveyor, said first velocity component being perpendicular to the feed direction.
Clause 4. The method of any of preceding clauses, wherein the at least one moving fluid jet cutting head is arranged to provide a moving fluid cutting jet having a second velocity component on the first belt conveyor along the feed direction, said second velocity component being substantially equal to the feed velocity.
Clause 5. The method of any of clauses 1-2, wherein the animal material is cut with a fluid jet cutting device comprising: a first belt conveyor defining a feed direction; at least one fixed fluid jet cutting head being arranged to provide a fluid cutting jet to the first belt conveyor; a second belt conveyor defining a second feed direction; and at least one fixed fluid jet cutting head being arranged to provide a fluid cutting jet to the second belt conveyor, wherein said feed direction and said second feed direction are non-parallel, preferably wherein the feed direction and the second feed direction are substantially orthogonal.
Clause 6. The method of any of the preceding clauses, wherein the fluid jet cutting device comprises at least two fixed fluid jet cutting heads, preferably at least three fixed fluid jet cutting heads.
Clause 7. The method of any of the preceding clauses, wherein the fluid cutting jet is provided at a pressure of at least 3000 bar, preferably at least 5000 bar, more preferably at least 5400 bar, still more preferably at least 6000 bar.
Clause 8. The method of any of the preceding clauses, wherein the at least one fluid jet cutting head comprises a cutting head orifice of between 0.01 mm and 1 mm, preferably of between 0.05 mm and 0.5 mm, more preferably of between 0.1 mm and 0.3 mm, still more preferably of between 0.15 mm and 0.2 mm.
Clause 9. The method of any of the preceding clauses, wherein the animal material comprises animal material wherein the skins are stacked prior to cutting the animal material with the fluid cutting jet, the stack having a thickness of between about 0.1 cm and 40 cm, preferably of between about 0.5 cm and 30 cm, more preferably of between about 1 cm and 20 cm, still more preferably of between about 2 cm and 15 cm.
Clause 10. The method of any of the preceding clauses, wherein the fluid cutting jet comprises an abrasive material, wherein preferably the abrasive material comprises a solid food-grade material.
Clause 11. A fluid jet cutting device for cutting animal material for the production of gelatine, said fluid jet cutting device comprising:
   a. a first belt conveyor defining a feed direction;
   b. at least one fixed fluid jet cutting head, preferably at least three fluid jet cutting heads, arranged to provide a fixed fluid cutting jet; and
   c. at least one moving fluid jet cutting head, arranged to provide a moving fluid cutting jet, the moving fluid cutting jet being arranged to achieve a first velocity component on the first belt conveyor, said first velocity component being perpendicular to the feed direction.
Clause 12. The fluid jet cutting device of clause 11, wherein the first belt conveyor is arranged to achieve a feed velocity in the feed direction and wherein the at least one moving fluid jet cutting head is arranged to move diagonally over the first belt conveyor, the moving fluid cutting jet having a second velocity component on the first belt conveyor, along the feed direction being equal to the feed velocity.
Clause 13. The fluid jet cutting device of clause 11 or 12, wherein the fluid jet cutting device comprises 2-10 fixed cutting heads, said fixed cutting heads preferably being provided at a predetermined distance to each other in a direction orthogonal to the feed direction.
Clause 14. The fluid jet cutting device of one of clauses 11-13, wherein the fluid jet cutting heads are provided at an adjustable height above the first belt conveyor of between 1 cm and 50 cm, preferably of between 5 cm and 30 cm, more preferably of between 10 cm and 20 cm.
Clause 15. The fluid jet cutting device of one of clauses 11-14, wherein the fluid jet cutting heads are arranged to introduce an abrasive material in the fluid cutting jets, preferably wherein the abrasive material comprises a solid food-grade material.
Clause 16. Use of the fluid jet cutting device according to any of clauses 11-15 for cutting animal material for the production of gelatine.

1. A method for producing gelatine, the method comprising the steps of:
a. providing animal material containing collagen;
b. cutting the animal material with at least one fluid cutting jet to form animal material sections;
c. hydrolysing the collagen in the animal material sections to form gelatine; and
d. isolating the gelatine.

2. The method of claim 1, wherein step b. further comprises stabilizing the animal material with stabilizing means, preferably by compressing the animal material with at least one compressing roller, more preferably wherein step b. further comprises compressing the animal material using two compressing rollers arranged to have at least one fluid cutting jet in between.

3. The method of any of the preceding claims, wherein the method further comprises the steps of:
providing the animal material using a first belt conveyor defining a feed direction, wherein the first belt conveyor transports the animal material with a feed velocity in the feed direction;
cutting the animal material using at least one fixed fluid jet cutting head; and
cutting the animal material using at least one moving fluid jet cutting head, arranged to provide a moving fluid cutting jet, the moving fluid cutting jet being arranged to achieve a first velocity component on the first belt conveyor, said first velocity component being perpendicular to the feed direction.

4. The method of any of the preceding claims, the method further comprises a step of cutting the animal material using the at least one moving fluid jet cutting head which is arranged to provide a moving fluid cutting jet having a second velocity component on the first belt conveyor along the feed direction, said second velocity component being substantially equal to the feed velocity.

5. The method of any preceding claims, wherein the method further comprises cutting the animal material with a fluid jet cutting device comprising: a first belt conveyor defining a feed direction; at least one fixed fluid jet cutting head being arranged to provide a fluid cutting jet to the first belt conveyor; a second belt conveyor defining a second feed direction; and at least one fixed fluid jet cutting head being arranged to provide a fluid cutting jet to the second belt conveyor,
wherein said feed direction and said second feed direction are non-parallel, preferably wherein the feed direction and the second feed direction are substantially orthogonal.

6. The method of any of the preceding claims, wherein the fluid cutting jet comprises an abrasive material, wherein preferably the abrasive material comprises a solid food-grade material.

7. The method of any of the preceding claims, wherein the animal material is animal skin, preferably pig skin, beef hide, or fish skin.

8. A fluid jet cutting device for cutting animal material for the production of gelatine, said fluid jet cutting device comprising:
a. a first belt conveyor defining a feed direction;
b. at least one fixed fluid jet cutting head, preferably at least three fluid jet cutting heads, arranged to provide a fixed fluid cutting jet; and
c. at least one moving fluid jet cutting head, arranged to provide a moving fluid cutting jet, the moving fluid cutting jet being arranged to achieve a first velocity component on the first belt conveyor, said first velocity component being perpendicular to the feed direction.

9. The fluid jet cutting device of claim 8, wherein the fluid jet cutting device further comprises at least one stabilizing assembly, preferably a compressing roller assembly, configured to compress the animal material under the at least one fixed fluid jet cutting head and/or the at least one moving fluid jet cutting head.

10. The fluid jet cutting device of claim 8 or 9, wherein the at least one compressing roller assembly comprises two compressing rollers located on two sides of a fluid jet nozzle of the fixed or moving fluid jet cutting head.

11. The fluid jet cutting device of any of claims 8-10, wherein the first belt conveyor further comprises a belt with a plurality of openings, a base with a plurality of openings, and/or
wherein the first belt conveyor further comprises a set of cogwheels configured to mechanically connected to the belt by using the plurality of openings of the belt.

12. The fluid jet cutting device of claim 8, wherein the first belt conveyor is arranged to achieve a feed velocity in the feed direction and wherein the at least one moving fluid jet cutting head is arranged to move diagonally over the first belt conveyor, the moving fluid cutting jet having a second velocity component on the first belt conveyor, along the feed direction being equal to the feed velocity.

13. The fluid jet cutting device of one of claims 8-12, wherein the fluid jet cutting device further comprises first and second connecting arms connected via first and second vertical connecting members configured to allow the fluid jet cutting head to move in a vertical direction.

14. The fluid jet cutting device of one of claims 8-13, wherein the fluid jet cutting heads are arranged to introduce an abrasive material in the fluid cutting jets, preferably wherein the abrasive material comprises a solid food-grade material.

15. Use of the fluid jet cutting device according to any of claims 8-14 for cutting animal material for the production of gelatine.
